(19) United States
(12) Patent Application Publication
(10) Pub. No.: US 2026/0006306 A1
(43) Pub. Date: Jan. 1, 2026

(54) Structured light projection with local control of polarization properties

(71) Applicant: Apple Inc., Cupertino, CA (US)

(72) Inventors: Muhammad A. Zaidi, San Diego, CA (US); Bernhard Buettgen, San Jose, CA (US)

(21) Appl. No.: 19/204,652

(22) Filed: May 12, 2025

Related U.S. Application Data
(60) Provisional application No. 63/665,845, filed on Jun. 28, 2024.

(51) Int. Cl. H04N 23/56; G02B 27/42

(52) U.S. Cl. CPC H04N 23/56; G02B 27/4233; G02B 27/4261

(57) ABSTRACT

An optical projection device includes an emitter, which is configured to emit a beam of coherent light. An optical substrate is disposed in a path of the beam. A metasurface is disposed on the optical substrate and includes an array of diffractive structures configured to modulate a polarization of the light so as to project a far-field pattern of interleaved areas having different, respective degrees of polarization.

### CROSS-REFERENCE TO RELATED APPLICATION

This application claims the benefit of U.S. Provisional Patent Application 63/665,845, filed Jun. 28, 2024, which is incorporated herein by reference.

### FIELD

The present invention relates generally to optical systems, and particularly to methods and devices for projecting and sensing polarized light.

### BACKGROUND

The state of polarization of light can be characterized using the Stokes parameters S₀, S₁, S₂, and S₃, which are defined as follows:

$$\begin{matrix}{S}_{0} = I \\ {S}_{1} = {I}_{x} - {I}_{y} \\ {S}_{2} = {I}_{45} - {I}_{- 45} \\ {S}_{3} = {I}_{R} - {I}_{L} .\end{matrix}$$

Here I denotes the total light intensity; Iₓ and I_{y} are the partial intensities of light linearly polarized along the x and y axes; I₄₅ and I₋₄₅ are the partial intensities linearly polarized along axes at +45° and −45°; and I_{R} and I_{L} are the partial intensities with right and left circular polarizations, respectively. For fully polarized light, S₀=√S̅₁̅²̅+̅S̅₂̅²̅+̅S̅₃̅²̅. The state of polarization of a beam of light can be defined by the vector <S₁, S₂, S₃>. The degree of polarization (DOP) of the beam is defined as:

$$DOP = \frac{\sqrt{{S}_{1}^{2} + {S}_{2}^{2} + {S}_{3}^{2}}}{{S}_{0}}$$

The value of DOP varies between zero for unpolarized light and one for fully polarized light.

The terms “light” and “optical radiation,” as used in the present description and in the claims, refer to electromagnetic radiation in any of the visible, infrared, and ultraviolet ranges of the spectrum. Optical metasurfaces are thin layers that comprise a two-dimensional pattern of diffractive structures, having dimensions (pitch and thickness) less than the target wavelength of the radiation with which the metasurface is designed to interact. Optical elements comprising optical metasurfaces are referred to herein as “metasurface optical elements” (MOEs).

Arbabi et al. describe a method for polarization control using metasurfaces in “Vectorial holograms with a dielectric metasurface: ultimate polarization pattern generation,” published in ACS Photonics 6, pages 2712-2718 (2019). The authors demonstrate vectorial holograms with almost arbitrary polarization patterns using structurally birefringent dielectric metasurfaces.

Some cameras capable detecting image are of polarization, i.e., in addition to sensing the intensity and color in an image of a scene, the camera also senses the state of polarization of the light that is received from different points in the scene. Cameras of this sort are referred to herein as “polarization-sensitive cameras.” Such cameras are described, for example, in U.S. Pat. No. 8,760,517, whose disclosure is incorporated by reference. For example, the camera may include a mosaic polarizer, as shown in FIG. 3 of this patent, or a variable polarizer in front of the image sensor, as shown in FIG. 8.

### SUMMARY

Embodiments of the present invention that are described hereinbelow provide devices and methods for generating and using structured patterns of polarization.

There is therefore provided, in accordance with an embodiment of the invention, an optical projection device, including an emitter, which is configured to emit a beam of coherent light, and an optical substrate disposed in a path of the beam. A metasurface is disposed on the optical substrate and includes an array of diffractive structures configured to modulate a polarization of the light so as to project a far-field pattern of interleaved areas having different, respective degrees of polarization.

In a disclosed embodiment, the interleaved areas define a grid over which the degrees of polarization of the areas vary periodically. Additionally or alternatively, the metasurface is configured so that at least some of the areas in the pattern have different, respective states of polarization. Further additionally or alternatively, the diffractive structures include nanopillars having respective dimensions and orientations chosen to generate the far-field pattern.

In some embodiments, the device includes a camera, which is configured to capture an image of a target onto which the far-field pattern is projected and to output image information including the respective degrees of polarization of pixels in the image. In a disclosed embodiment, the device includes a controller, which is configured to process the image by comparing the respective degrees of polarization of the pixels in the image to the far-field pattern projected by the optical metasurface.

There is also provided, in accordance with an embodiment of the invention, a method for sensing, which includes projecting onto a target a pattern of light including interleaved areas having different, respective degrees of polarization and capturing an image of the target. The image is processed by comparing the respective degrees of polarization of the pixels in the image to the projected pattern.

In a disclosed embodiment, projecting the pattern includes directing a beam of coherent light to impinge on a metasurface including an array of diffractive structures configured to modulate a polarization of the light so as to project the pattern of interleaved areas in the far field. In a disclosed embodiment, processing the image further includes detecting respective states of polarization of the pixels in the image.

There is additionally provided, in accordance with an embodiment of the invention, a method for producing a metasurface, which includes defining a desired far-field pattern of projected light including interleaved areas having different, respective degrees of polarization. A profile of diffractive structures on the metasurface is selected for imparting the desired far-field pattern to an incident beam of coherent light. A far-field response of the profile is computed, and a correction to the profile is computed and applied based on a difference between the degrees of polarization of the interleaved areas in the computed far-field response and in the desired far-field pattern. The steps of computing the far-field response of the profile and computing and applying the correction are repeated until the degrees of polarization of the interleaved areas in the computed far-field response match the desired far-field pattern to within a predefined bound, thereby defining a final profile of the diffractive structures. The metasurface is fabricated on a substrate in accordance with the final profile.

In a disclosed embodiment, defining the desired far-field pattern further includes defining respective states of polarization of the interleaved areas, wherein the correction is further computed so as to bring the states of polarization of the interleaved areas in the computed far-field response into accordance with the desired far-field pattern.

In some embodiments, the diffractive structures include nanopillars, and selecting the profile includes defining respective dimensions and orientations of the nanopillars so as to generate the far-field pattern.

### BRIEF DESCRIPTION OF THE DRAWINGS

The present invention will be more fully understood from the following detailed description of the embodiments thereof, taken together with the drawings in which:

FIG. 1 is a schematic side view of a polarization-based imaging system, in accordance with an embodiment of the invention;

FIG. 2 is a schematic pictorial illustration of a projection device, which projects light with a structured pattern of polarization, in accordance with an embodiment of the invention;

FIGS. 3A, 3B, 3C, and 3D are schematic frontal views showing a degree of polarization (DOP) and polarization components (S₁, S₂, S₃) of a structured pattern of projected light, in accordance with an embodiment of the invention;

FIG. 4A is a schematic detail view of a metasurface optical element (MOE), in accordance with an embodiment of the invention; and

FIG. 4B is a flow chart that schematically illustrates a method for designing an MOE to project a structured pattern of light with a desired far-field polarization pattern, in accordance with an embodiment of the invention.

### DETAILED DESCRIPTION

Structured light patterns are commonly used in three-dimensional (3D) sensing applications. In such applications, a pattern of illumination is projected onto a scene, and a camera captures images of the scene with the projected pattern. Displacement and distortion of the pattern in the image, compared to the original projected pattern, can be measured to extract information regarding the shapes and depths of objects in the scene.

Although structured illumination is usually characterized by a pattern of intensity that varies across the scene, embodiments of the present invention that are described herein extend these principles to the realm of polarization. Specifically, in the disclosed embodiments, a metasurface, disposed on an optical substrate, modulates the polarization of a beam of coherent light so as to project a far-field pattern of interleaved areas having different, respective degrees of polarization. Typically (although not necessarily), the interleaved areas define a grid over which the degrees of polarization of the areas vary periodically. In some embodiments, the metasurface modulates the polarization so that at least some of the areas in the pattern also have different, respective states of polarization.

In some embodiments, a polarization-sensitive camera captures an image of a target onto which the far-field polarization pattern is projected and outputs image information that includes the respective degrees of polarization of pixels in the image. The polarization pattern in the image can be compared to the projected pattern to extract information regarding the target. For example, distortion and displacement of the pattern can be used to extract depth and shape information. Additionally or alternatively, changes in the degree of polarization can be analyzed to derive information regarding the specular and diffuse reflection properties of the target surface.

Furthermore, in contrast to the intensity variations that occur across conventional structured light patterns, the projected pattern of varying polarization provided by embodiments of the present invention can have a constant intensity across the target. Therefore, the projected polarization pattern may simultaneously provide uniform flood illumination for a polarization-insensitive camera that is used to capture two-dimensional (2D) images of the target.

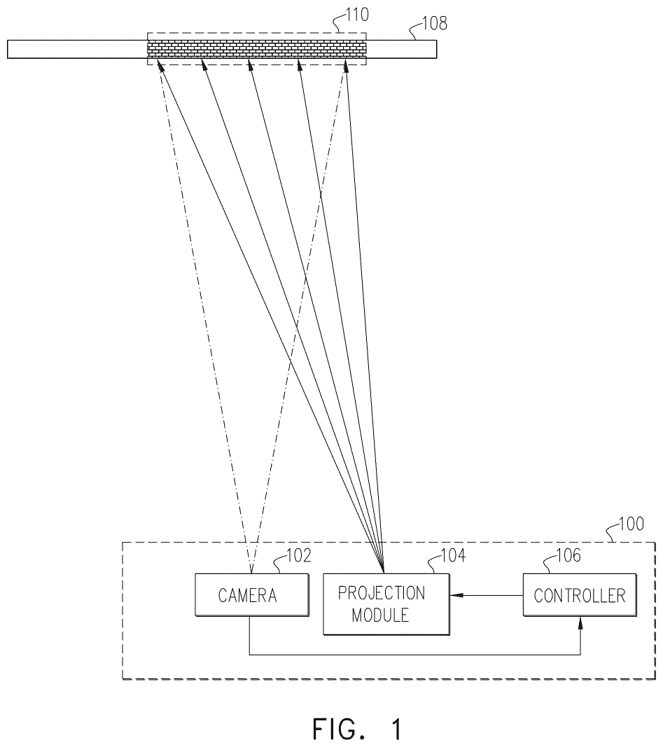

FIG. 1 is a schematic side view of polarization-based imaging system 100, in accordance with an embodiment of the invention. System 100 comprises a polarization-sensitive camera 102, an optical projection device 104, and a controller 106.

Projection device 104 projects a pattern 110 of light onto a target 108. Pattern 110 comprises interleaved areas having different, respective degrees of polarization (and possibly different states of polarization). Camera 102 captures an image of target 108 including pattern 110 and outputs image information including the respective degrees of polarization of pixels in the image. For this purpose, for example, camera 102 may include polarization components as described in the above-mentioned U.S. Pat. No. 8,760,517. Controller 106 processes the image by comparing the respective degrees of polarization of the pixels in the image to the known characteristics of projected pattern 110, as projected by device 104.

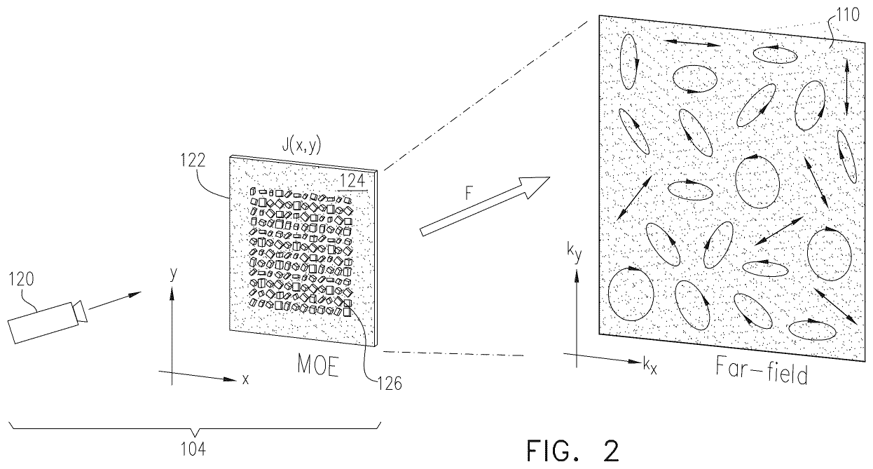

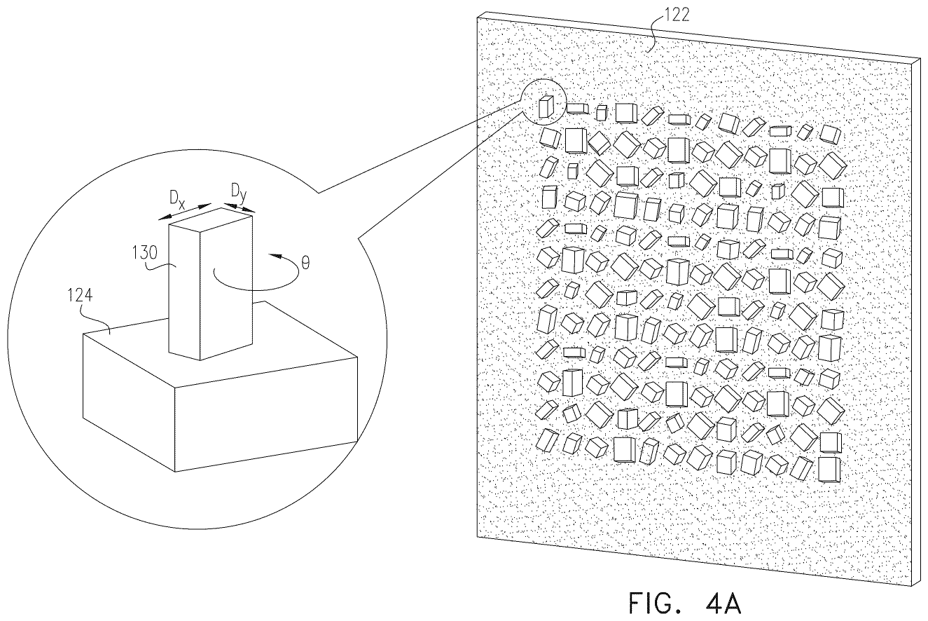

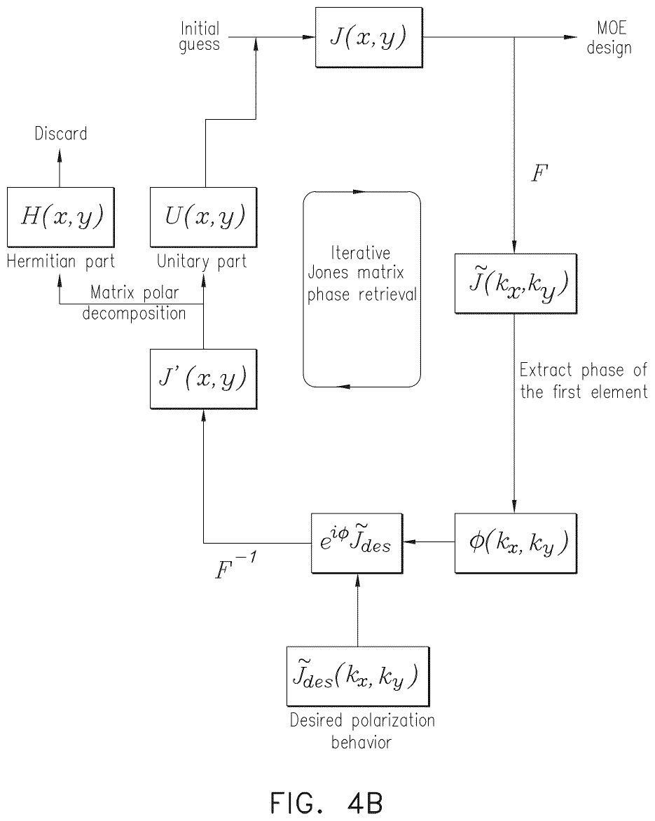

FIG. 2 is a schematic pictorial illustration of projection device 104, in accordance with an embodiment of the invention. Device 104 comprises an emitter 120, such as a vertical-cavity surface-emitting laser (VCSEL), which emits a beam of coherent light, which in the present example is unpolarized. An MOE 122 is positioned in the path of the beam. MOE 122 comprises an optical substrate 124, such as a glass blank, with a metasurface 126 comprising an array of diffractive structures (for example nanopillars 130 as shown in FIG. 4A). Metasurface 126 modulates the polarization of the light to project pattern 110 in the far field. As noted earlier, pattern 110 is made up of interleaved areas having different, respective degrees of polarization.

The effect of MOE 122 on the polarization of a beam of light can be expressed in terms of Jones calculus. In this context, the Jones vector contains two complex elements that represent the amplitude and phase of the electric field of the light wave in the x and y directions, respectively. The effect of a given optical element on an incident beam is described by a 2×2 Jones matrix. The effects of MOE 122, which applies local changes to the polarization of incident light, can be expressed as a spatially varying Jones matrix J(x, y), wherein x and y are location coordinates in the plane of the metasurface. Details of the Jones matrix for a metasurface made up of an array of nanopillars are described hereinbelow with reference to FIG. 4A.

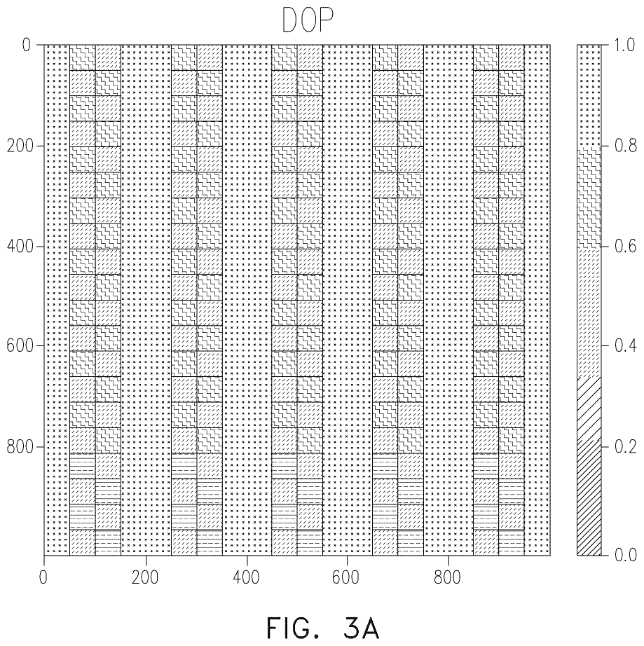

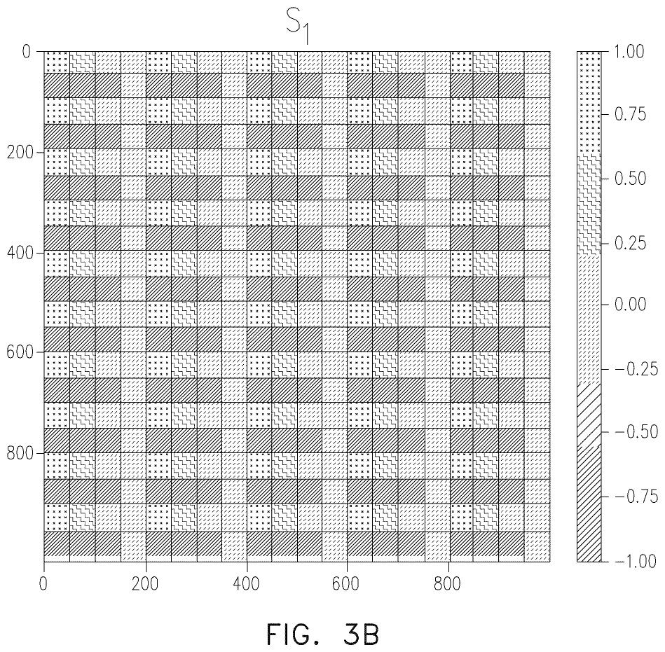

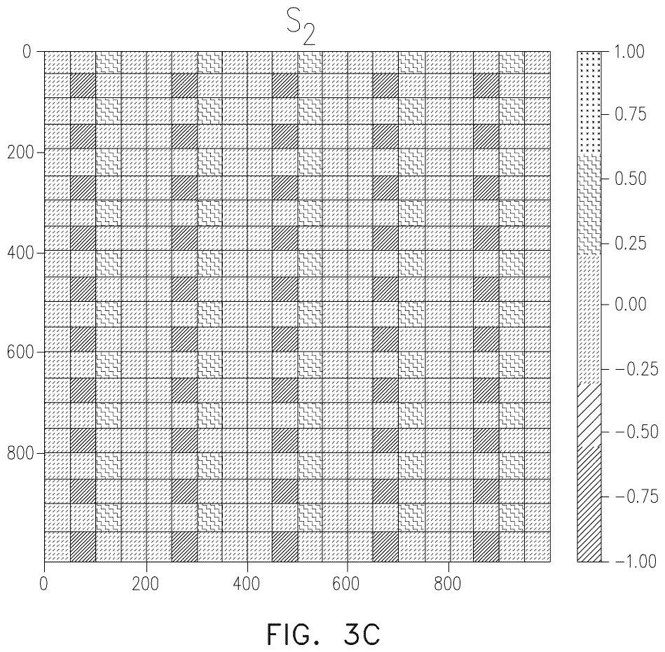

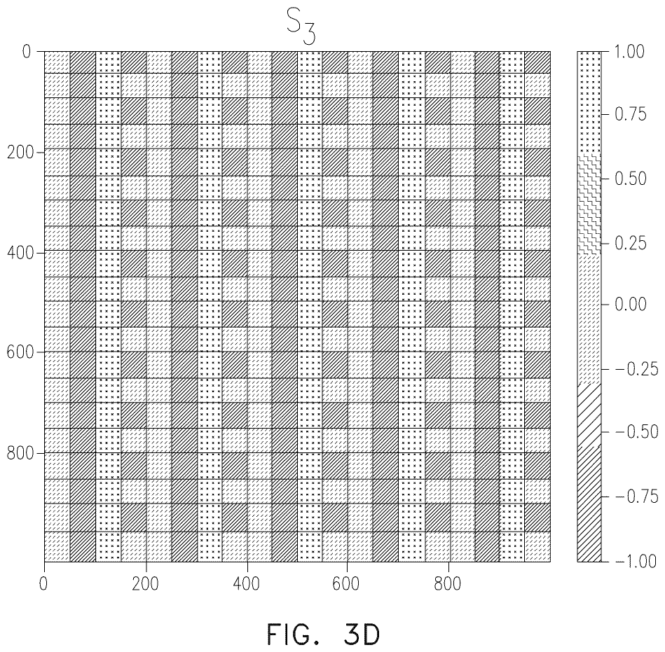

FIGS. 3A, 3B, 3C, and 3D are schematic frontal views showing a degree of polarization (DOP) and polarization components (S₁, S₂, S₃) of a structured pattern of projected light, in accordance with an embodiment of the invention. Pattern 110 comprises a grid of dimensions 1000×1000 pixels, in which each area (of dimensions 50×50 pixels) has its own values of S₁, S₂, S₃, and DOP, as indicated by the hatching scales in the figure. Thus, areas having different DOP and different SOP are interleaved in the grid pattern. Groups of 2×2 adjacent areas in this pattern define periodic variations in DOP and SOP. Different areas in the pattern may all have the same intensity (S₀), and provide uniform illumination for purposes of unpolarized imaging, or they may have different intensities to encode further information into the illumination pattern.

Far-field polarization patterns of the sort shown in FIG. 3 can be defined arbitrarily and serve as the starting point for computing the profile of metasurface 126 to generate the pattern as described below.

Polarization pattern 110 in the far field can be written as \tilde{J}(kₓ, k_{y}), wherein kₓ and k_{y} are angular coordinates, and \tilde{J} is the spatial Fourier transform of the Jones matrix J(x, y). As noted above, the far-field polarization pattern \tilde{J}(kₓ, k_{y}), comprises a pattern of interleaved areas, such as a grid pattern, with different, respective degrees of polarization. The areas may also have different states of polarization. Given a desired far-field pattern of this sort, \tilde{J}(kₓ, k_{y}), the corresponding Jones matrix J(x, y) can be computed by an iterative process of phase retrieval and optimization. The profile of the diffractive structures making up metasurface 126, such as an array of nanopillars, can be derived from J(x, y) using finite-difference time-domain (FDTD) simulation. Methods for producing a metasurface using these techniques are described below with reference to FIGS. 4A and 4B.

FIG. 4A is a schematic detail view of MOE 122, in accordance with an embodiment of the invention. In this example, the metasurface is made up of rectangular nanopillars 130, having respective transverse dimensions D_{X} and D_{y} and orientation angles θ. As noted earlier, the dimensions of the nanopillars are less than the target wavelength of light that MOE 122 is to modulate and are typically the order of tens of nanometers. The dimensions and orientations of the nanopillars vary across the area of the metasurface in a pattern that is chosen to generate the desired far-field polarization pattern, such as the pattern shown in FIG. 3. MOEs of this sort are produced by photolithographic processes and are commercially available from vendors such as STMicroelectronics. Nanopillars 130 typically comprise amorphous silicon; but alternatively, the nanostructures making up the metasurface may comprise other sorts of semiconductor, dielectric, or metallic materials.

Further alternatively, the principles of the systems and methods described herein may be implemented, mutatis mutandis, using optical metasurfaces of other types. All such alternative implementations are considered to be within the scope of the present invention.

As noted above, the polarization effect of the pattern of nanopillars 130 on MOE 122 can be expressed in terms of a Jones matrix, which can be written as:

$${J}_{MOE} ( x , y ) = R ( - θ ( x , y ) ) ( \begin{matrix}{e}^{i {ϕ}_{X} ( x , y )} & 0 \\ 0 & {e}^{i {ϕ}_{Y} ( x , y )}\end{matrix} ) R ( θ ( x , y ) )$$

In this formula, the phases ϕₓ and ϕ_{y} are the local phase delays induced by the dimensions Dₓ and D_{y}, and the rotation matrix

$$R ( θ ) = ( \begin{matrix}cos θ & sin θ \\ - sin θ & cos θ\end{matrix} ) .$$

The far-field polarization pattern can be calculated as the Fourier transform of the Jones matrix of the MOE:

$$\tilde{J} ( {k}_{x} , {k}_{y} ) = \int \int {J}_{MOE} ( x , y ) {e}^{i ( {k}_{x} , x + {k}_{y} , y )} dxdy$$

FIG. 4B is a flow chart that schematically illustrates a method for designing MOE 122 to project a structured pattern of light with a desired far-field polarization pattern, in accordance with an embodiment of the invention. The present implementation uses a metasurface made up of nanopillars, and it assumes that the intensity of the projected pattern is uniform, as explained above. Therefore, only phase components, not intensity, are considered in the process of designing the MOE. This sort of method, carried out iteratively, is referred to as a phase retrieval process.

The method of FIG. 4B, begins with a definition of the desired far-field pattern of projected light \tilde{J}_{des}(kₓ, k_{y}), which comprises interleaved areas having different, respective degrees of polarization. An initial profile of diffractive structures on the metasurface, defined by the local Jones matrix J(x, y), is selected for imparting the desired far-field pattern to an incident beam of coherent light. The initial selection may be made empirically from first principles or based on experience with other, similar MOEs. A computer calculates the far-field response of the profile \tilde{J}(kₓ, k_{y}), a spatial Fourier transform as described above.

A correction to the profile is then computed based on the difference between the degrees of polarization of the interleaved areas in this computed far-field response \tilde{J}(kₓ, k_{y}) and in the desired far-field pattern \tilde{J}_{des}(kₓ, k_{y}). In the present example, to compute the correction, the phase component ϕ(kₓ, k_{y}) is extracted from \tilde{J}(kₓ, k_{y}) and applied as a rotation to the desired pattern \tilde{J}_{des}, giving the rotated pattern e^{iϕ}\tilde{J}_{des} as a function of (kₓ,k_{y}), as shown in FIG. 4B. A new Jones matrix for the metasurface J′(x, y) is computed as the inverse Fourier transform of elfdes. The unitary (phase only) part of J′(x, y) is extracted, while the Hermitian part is discarded.

This unitary part of J′(x, y) serves as a new Jones matrix for the next iteration of the phase retrieval process. The steps of computing the far-field response of this new profile and then computing and applying the correction are repeated, as shown in FIG. 4B, until the degrees of polarization and states of polarization of the interleaved areas in the computed far-field response match the desired far-field pattern to within a predefined bound. (Alternatively, only the degree of polarization may be specified, while the state of polarization is randomized.) The final Jones matrix J′(x, y) that gave rise to this computed far-field response provides the final profile J_{MOE} of the diffractive structures on the metasurface.

To fabricate a metasurface that will give rise to this final profile, the local phase characteristics of the Jones matrix are translated into nanopillar dimensions Dₓ, D_{y} and rotation angle θ. For this purpose, FDTD simulations can be used to construct a library of nanopillar dimensions and the corresponding phase effects. For each local phase pair (ϕ_{X}, ϕ_{Y}), the nanopillar dimensions that give the closest phase response are chosen and incorporated in the mask that will be used in the photolithographic process of fabricating the MOE.

The embodiments described above are cited by way of example, and the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An optical projection device, comprising:
an emitter, which is configured to emit a beam of coherent light;
an optical substrate disposed in a path of the beam; and
a metasurface disposed on the optical substrate and comprising an array of diffractive structures configured to modulate a polarization of the light so as to project a far-field pattern of interleaved areas having different, respective degrees of polarization.

2. The device according to claim 1, wherein the interleaved areas define a grid over which the degrees of polarization of the areas vary periodically.

3. The device according to claim 1, wherein the metasurface is configured so that at least some of the areas in the pattern have different, respective states of polarization.

4. The device according to claim 1, wherein the diffractive structures comprise nanopillars having respective dimensions and orientations chosen to generate the far-field pattern.

5. The device according to claim 1, and comprising a camera, which is configured to capture an image of a target onto which the far-field pattern is projected and to output image information including the respective degrees of polarization of pixels in the image.

6. The device according to claim 5, and comprising a controller, which is configured to process the image by comparing the respective degrees of polarization of the pixels in the image to the far-field pattern projected by the optical metasurface.

7. A method for sensing, comprising:
projecting onto a target a pattern of light comprising interleaved areas having different, respective degrees of polarization;
capturing an image of the target; and
processing the image by comparing the respective degrees of polarization of the pixels in the image to the projected pattern.

8. The method according to claim 7, wherein projecting the pattern comprises directing a beam of coherent light to impinge on a metasurface comprising an array of diffractive structures configured to modulate a polarization of the light so as to project the pattern of interleaved areas in the far field.

9. The method according to claim 7, wherein processing the image further comprises detecting respective states of polarization of the pixels in the image.

10. A method for producing a metasurface, comprising:
defining a desired far-field pattern of projected light comprising interleaved areas having different, respective degrees of polarization;
selecting a profile of diffractive structures on the metasurface for imparting the desired far-field pattern to an incident beam of coherent light;
computing a far-field response of the profile;
computing and applying a correction to the profile based on a difference between the degrees of polarization of the interleaved areas in the computed far-field response and in the desired far-field pattern;
repeating the steps of computing the far-field response of the profile and computing and applying the correction until the degrees of polarization of the interleaved areas in the computed far-field response match the desired far-field pattern to within a predefined bound, thereby defining a final profile of the diffractive structures; and
fabricating the metasurface on a substrate in accordance with the final profile.

11. The method according to claim 10, wherein defining the desired far-field pattern further comprises defining respective states of polarization of the interleaved areas, wherein the correction is further computed so as to bring the states of polarization of the interleaved areas in the computed far-field response into accordance with the desired far-field pattern.

12. The method according to claim 10, wherein the diffractive structures comprise nanopillars, and wherein selecting the profile comprises defining respective dimensions and orientations of the nanopillars so as to generate the far-field pattern.
